(19) United States
(12) Patent Application Publication
(10) Pub. No.: US 2008/0086266 A1
(43) Pub. Date: Apr. 10, 2008

(54) System and method for storing a vehicle location on the occurrence of an error

(76) Inventors: Dwight A. Howard, Carmel, IN (US); Brian L. Bickford, Kokomo, IN (US)

Correspondence Address: DELPHI TECHNOLOGIES, INC., M/C 480-410-202, PO BOX 5052, TROY, MI, 48007, US

(21) Appl. No.: 11/542,931

(22) Filed: Oct. 4, 2006

(51) Int. Cl. G01C 21/00

(52) U.S. Cl. 701/213; 701/207; 340/988

(57) ABSTRACT

A system for storing the location of a vehicle during an error condition is provided. The system includes one or more vehicle electronics devices that include memory, and are configured to detect an error condition associated with the vehicle electronics device(s). The system also includes a location determination device coupled to the vehicle electronics device and configured to determine a vehicle location and provide information indicative of the determined vehicle location. The vehicle electronics device(s) are configured to store vehicle location information provided by the location determination device in memory. The stored vehicle location information is indicative of the location of the vehicle at the time an error condition is detected by the vehicle electronic device. Methods for storing the location of a vehicle during an error condition are also provided.

### TECHNICAL FIELD

The present invention relates generally to storing and retrieving error information for vehicle electronics devices, and more specifically, to the storage and retrieval of vehicle location information associated with errors occurring in vehicle electronics devices.

### BACKGROUND OF THE INVENTION

Trucks, boats, automobiles, and other vehicles are commonly equipped with various electronic modules and devices to perform functions related to the operation of the vehicle and/or services for vehicle occupants. Examples of electronics modules typically employed to assist in the control and/or operation of the vehicle include engine control modules for controlling the operation of the vehicle engine, anti-lock brake system (ABS) modules for providing ABS braking capability, suspension control modules for regulating the operation of the vehicle suspension system, airbag modules for regulating the deployment of vehicle airbags in the event of an accident, and stability control system modules for providing improved vehicle handling in potentially unstable driving situations. Examples of electronics modules typically employed in a vehicle to provide vehicle occupants with services include vehicle audio modules for providing analog and/or digital radio services and CD audio services to vehicle occupants, navigation modules including global positioning system (GPS) circuitry for providing vehicle location information to vehicle occupants, emergency services modules, such as, for example, OnStar®, for providing vehicle occupants with concierge and/or safety related services, satellite modules for transmitting and/or receiving audio and/or data to and from the vehicle, cellular phone modules for providing a cellular communication link to occupants of the vehicle, and wireless transmit and/or receive modules for providing vehicle occupants with a wireless interface between portable electronics devices and electronics devices located in the vehicle.

Conventional vehicle electronics modules and/or devices described above generally may each have the ability to detect error conditions within the module and/or device, and to store error information within the electronic module and/or device itself for later retrieval for diagnostic purposes. For example, an ABS module may be configured to detect a defective condition in the wheel speed sensor, and store an error code within the ABS module, indicating that there is an error condition in the wheel speed sensor. In another example, an engine control module may be configured to detect a misfire in a cylinder of the engine, and store an error code indicating that a cylinder has misfired within the engine control module for later retrieval for diagnostic purposes.

Although the conventional electronics modules and/or devices described above may be configured to store an error code, indicating an error condition in the module, the lack of additional information related to the error can make the ultimate diagnosis of the root cause of the error condition difficult, if not impossible. This is especially true if the additional information that would be helpful in diagnosing the root cause of the error condition pertains to the location of the vehicle at the time the error condition occurred. Because typical electronics modules and/or devices do not store information pertaining to the location of the vehicle when an error condition occurs, the ultimate root cause of error conditions in certain circumstances may never be identified and addressed. For example, if a serious pothole in the road causes damage to the wheel speed sensor of a wheel when the wheel impacts the pothole, it would be helpful to know the location of the vehicle, and therefore the pothole, at the time the error occurred. However, in a typical ABS module, a technician diagnosing the problem will be unable to determine the location of the vehicle at the time the wheel speed sensor was damaged, because vehicle location information is not typically stored in the ABS module.

In another example, a typical satellite receive module may be configured to detect when no satellite signal is available, and capture that event as an error in the satellite receive module. However, a technician attempting to diagnose when a satellite signal was lost would be unable to determine the vehicle location, because vehicle satellite receivers do not typically store the location of the vehicle indicative of when a satellite signal was lost.

As noted above, the inability to determine the location of a vehicle at the time an error occurs in the conventional vehicle electronics module and/or device can make it difficult, if not impossible, to identify and resolve the root cause of the error condition.

What is needed is a system and method for storing the location of a vehicle during an error condition.

### SUMMARY OF THE INVENTION

In accordance with one aspect of the present invention, a system for storing the location of a vehicle during an error condition is provided. The system includes a vehicle electronics device including memory. The vehicle electronics device is configured to perform a first function, and is also configured to detect an error condition associated with the vehicle electronics device. The system further includes a location determination device coupled to the vehicle electronics device and configured to determine a vehicle location and provide information indicative of the determined vehicle location. The vehicle electronics device is still further configured to store vehicle location information provided by the location determination device in memory when an error condition is detected. The stored vehicle location information is indicative of the location of the vehicle at the time an error condition is detected by the vehicle electronic device.

In accordance with another aspect of the present invention, a method for storing the location of a vehicle during occurrence of an error condition is provided. The method includes the step of detecting an error condition in a vehicle electronics module. The method further includes the step of determining the vehicle location near the time of the detected error condition in a location determination device coupled to the vehicle electronics module. The method still further includes the steps of providing the determined vehicle location to the vehicle electronics module and storing the determined vehicle location in the vehicle electronics module.

In accordance with yet another aspect of the present invention, a method for storing the location of a vehicle during occurrence of an error condition is provided. The method includes the steps of detecting an error condition in a vehicle electronics module coupled to a communication bus and sending a location request via the communication bus requesting a location of the vehicle near the time of the detected error condition. The method further includes the steps of receiving the location request in a navigation module coupled to the communication bus and determining the location of the vehicle near the time of the detected error condition in the navigation module. The method still further includes the steps of sending information indicative of the location of the vehicle near the time of the detected error condition via the communication bus and receiving the information indicative of the location of the vehicle near the time of the detected error condition in the vehicle electronics module. The method also includes the step of storing the information indicative of the location of the vehicle near the time of the detected error condition in memory of the vehicle electronics module.

In accordance with yet another aspect of the present invention, a method for storing the location of an electronics device during occurrence of a condition of interest is provided. The method includes the step of detecting a condition of interest in an electronics device. The method further includes the step of determining the electronics device location near the time of the detected condition of interest in a location determination device coupled to the electronics device. The method still further includes the step of storing the condition of interest information and the determined electronics device location near the time of the detected condition of interest in memory of the electronics device.

In accordance with still another aspect of the present invention, a system for storing the location of an electronics device during a condition of interest is provided. The system includes an electronics device including memory. The electronics device is configured to perform a first function, and is also configured to detect a condition of interest associated with the electronics device. The system further includes a location determination device coupled to the electronics device and configured to determine a location of the electronics device and provide information indicative of the determined location. The electronics device is still further configured to store electronics device location information provided by the location determination device in memory when a condition of interest is detected. The stored electronic device location information is indicative of the location of the electronics device at the time a condition of interest is detected by the electronics device.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a schematic diagram generally illustrating a vehicle including an electronics system having devices associated with the vehicle, according to one embodiment of the present invention;

FIG. 2 is a block diagram illustrating additional detail for the electronics system of the embodiment of FIG. 1; and

FIG. 3 is a flow diagram generally illustrating a method for storing the location of a vehicle during an error condition, according to one embodiment of the present invention.

### DESCRIPTION OF THE PREFERRED EMBODIMENTS

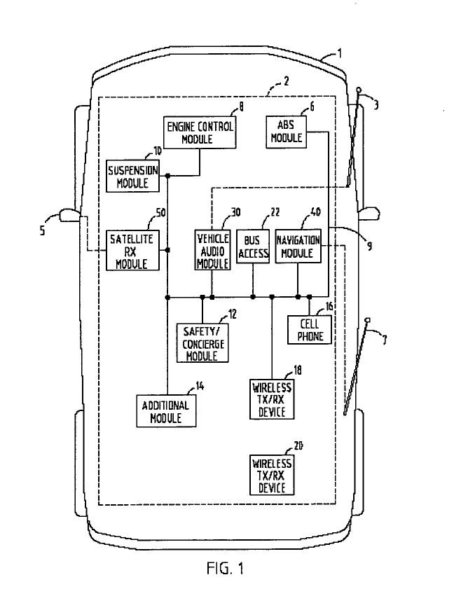

FIG. 1 generally illustrates a vehicle 1 having an electronics system 2 including various electronics devices and/or modules associated with the vehicle 1. System 2 includes a navigation module 40 electrically coupled to a GPS antenna 7. Navigation module 40 is a location determination device that includes circuitry configured to receive GPS signals from various GPS satellites, and determine the location of the vehicle 1 based on the information received from the GPS satellites. System 2 also includes an anti-lock brake system (ABS) module 6. ABS module 6 is configured to monitor the speeds of various wheels of the vehicle 1, determine if the wheels are in a locked condition, and modulate the pressure to the brakes, based on the information provided by the wheel speed sensors and user brake input, to help the driver maintain control of the vehicle 1 during a braking condition on a slippery surface. System 2 also includes engine control module 8, which is configured to control the operation of an engine providing power to the vehicle 1. System 2 also includes a suspension module 10, which is configured to adjust the ride of the vehicle 1 based on a number of factors, including, for example, user input.

System 2 is also shown including a satellite receive module 50 configured to receive satellite digital audio radio (SDAR). As shown, satellite receive module 50 is electrically coupled to a satellite antenna 5, which is configured to receive satellite signals. System 2 also includes a vehicle audio module 30 coupled to an antenna 3. As shown, vehicle audio module 30 is configured to receive traditional AM and FM radio broadcasts, decode the signals, and provide audio programming to occupants of the vehicle 1. Vehicle audio module 30 also includes a digital optical disc player configured to receive compact discs (CDs), and decode the data on the CDs to provide audio programming to occupants of the vehicle 1.

System 2 also includes a safety/concierge module 12 configured to provide an occupant of vehicle 1 with convenience information, such as, for example, location of restaurants, gas stations, or other services, and to provide occupants of the vehicle 1 a communications path to a help center in the event of an accident, or other emergency. System 2 also includes a cell phone 16 configured to send and receive voice and/or data information via a cellular network. As shown, system 2 may also include additional vehicle electronics modules and/or devices 14.

As shown, the above-referenced vehicle electronics modules are coupled together by a communication bus 9. In the present embodiment, the communication bus 9 is a GM-LAN bus. In alternate embodiments, communication bus 9 may be a bus other than a GM-LAN bus, and may be a wired bus, a wireless bus, or a combination wired and wireless bus. Examples of wired busses may include, for example, CAN, J-1850, MOST, USB, Firewire, I2C. Examples of wireless busses may include, for example, 802.11 and Bluetooth® wireless busses. Wireless busses are configured to allow information to be electromagnetically communicated among devices that are electromagnetically coupled to the bus, rather than being directly electrically coupled to the bus. Communication busses or paths other than those listed above may be employed in alternate embodiments, provided they allow modules to communicate data with each other. In the present embodiment, the bus 9 is configured such that the modules coupled to the bus 9 may share data with each other. As shown, system 2 also includes a wireless transmit/receive module 18 coupled to the communication bus 9. Wireless transmit/receive module 18 is configured to transmit and receive wireless signals from wireless devices proximate the vehicle 1, such as wireless transmit/receive device 20. Because wireless transmit/receive device 18 is coupled to the communication bus 9, information received from wireless transmit/receive device 20 by wireless transmit/receive device 18 may be communicated from wireless transmit/receive device 18 to modules and/or devices coupled to communication bus 9. In addition, information provided by various electronics modules and/or devices coupled to communication bus 9 to wireless transmit/receive module 18 may be transmitted by wireless transmit/receive device 18 to wireless transmit/receive device 20. In this manner, wireless transmit/receive device 20 may both send and/or receive data to and/or from the various electronics modules and/or devices coupled to the communication bus 9.

In the present embodiment, wireless transmit/receive device 18 is a Bluetooth™ transceiver, and wireless transmit/receive device 20 is an electronics device located proximate the vehicle 1 that includes a Bluetooth™ wireless transceiver. System 2 is also shown including a bus access port 22 coupled to a communication bus 9. Bus access port 22 is configured to allow an external diagnostic device to communicate with various electronics devices, such as control modules, etc., coupled to the communication bus 9, such that the diagnostic devices are able to send and/or receive information to and/or from the various electronics devices coupled to communication bus 9. In the present embodiment, bus access port 22 is configured to be electrically coupled to a Tech2 GM diagnostic tool, such that the Tech2 GM diagnostic tool can read codes from various electronics modules and/or devices coupled to the communication bus 9, and can send data to the various electronics modules and/or devices coupled to communication bus 9.

In the present embodiment, each of the modules described above includes non-volatile memory. In alternate embodiments, the memory included in various modules may include EEPROM, flash memory, and other volatile and non-volatile memory. Each of the modules is configured to determine when an error condition has occurred in the module, and to store an error code indicative of the error detected in the non-volatile memory of the module. For example, ABS module 6 is configured to determine when an error has occurred in ABS module 6, and to store an error code indicative of the detected error in non-volatile memory located within ABS module 6.

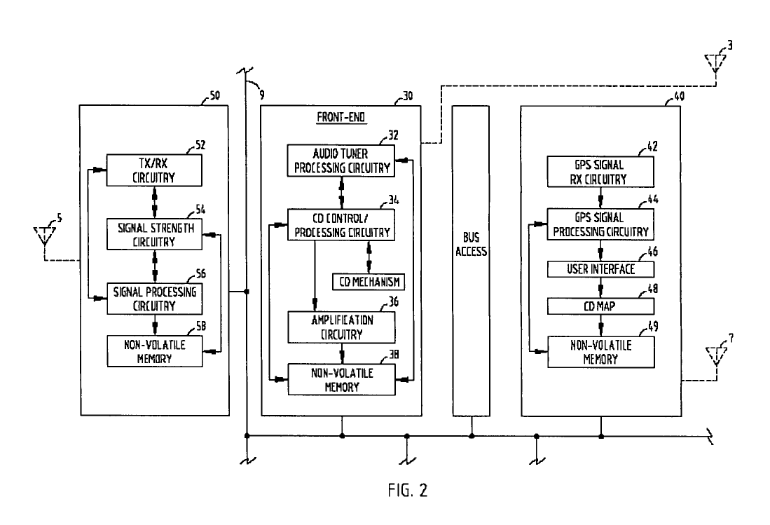

Referring to FIG. 2, additional detail of the satellite receive module 50, vehicle audio module 30, and navigation module 40 of electronics system 2 are shown. Satellite receive module 50 includes receive circuitry 52 configured to filter and amplify signals received via antenna 5. Receive circuitry 52 is shown coupled to signal strength circuitry 54. Signal strength circuitry 54 is configured to determine if a satellite signal is present, and if so, the strength of the satellite signal. Signal strength circuitry 54 is shown coupled to signal processing circuitry 56 and memory 58. In the present embodiment, memory 58 is flash memory. In alternate embodiments, memory 58 may include read only memory (ROM), EEPROM, and other non-volatile and volatile memory. Memory 58 is configured to store codes indicative of an error condition in satellite receive module 50. Signal processing circuitry 56 is also shown coupled to front end receive circuitry 52. Signal processing circuitry 56 is configured to process signals received via front end receive circuitry 52, and decode the signals to provide audio and/or data to occupants of vehicle 1.

In the present embodiment, satellite receive module 50 is configured to determine if a satellite signal is present, and if present, to further determine if the satellite signal is a signal having sufficient strength to provide acceptable audio and/or data to an occupant of vehicle 1. If satellite receive module 50 determines that a satellite signal is either not present, or is inadequate in terms of strength, satellite receive module 50 is configured to store an error code indicative of this error condition in memory 58.

In addition, satellite receive module 50 is configured to send a request to navigation module 40, requesting that navigation module 40 provide satellite receive module 50 with information indicative of the vehicle 1 location at the time satellite receive module 50 determined that the error condition occurred. Navigation module 40 includes GPS signal receive circuitry 42, which is configured to receive GPS signals from GPS satellites. Navigation module 40 also includes GPS signal processing circuitry 44 coupled to GPS signal receive circuitry 42. GPS signal processing circuitry 44 is configured to process the signals received from GPS signal receive circuitry 42, and evaluate those signals to determine the location of the vehicle 1 based on the received signals. In the present embodiment, GPS signal processing circuitry 44 uses the received signals to determine the latitude and longitude location coordinates of the vehicle 1.

Navigation module 40 also includes a user interface 46 coupled to GPS signal processing circuitry 44. User interface 46 is configured to display information indicative of the determined vehicle location. In the present embodiment, user interface 46 graphically displays the latitude and longitude location coordinates of the vehicle 1 on a map display. In alternate embodiments, user interface 46 may communicate the determined vehicle 1 location by other means, such as by audio means.

Navigation module 40 also includes compact disc (CD) map 48. CD map 48 is a CD including detailed information about various geographic locations, such as, for example, detailed topographical information, types and names of businesses at various geographical locations, street names, house numbers, and other map related information that might be of interest to occupants of vehicle 1. Navigation module 40 is configured such that the vehicle 1 location determined by GPS signal processing circuitry 44 is used in conjunction with the user interface 46, such that detailed information about the location in the vicinity of the vehicle 1 location is accessed on the CD map 48, and provided to vehicle 1 occupants via user interface 46 based on the determined vehicle 1 location. In this manner, the determined vehicle 1 location is used to ensure that the displayed detailed information from CD map 48 is relevant to the current vehicle 1 location.

Navigation module 40 is coupled to communication bus 9, and is configured to both send and receive information to and from other devices coupled to communication bus 9. When Navigation module 40 receives a request via communication bus 9 from satellite receive module 50 for the vehicle 1 location, Navigation module 40 provides information indicative of the vehicle 1 location to satellite receive module 50 via communication bus 9. In the present embodiment, navigation module 40 provides latitude and longitude location coordinate information indicative of the vehicle 1 location to satellite receive module 50. When satellite receive module 50 receives the information indicative of the vehicle 1 location at the time of the error condition from navigation module 40, satellite receive module 50 stores the information indicative of the vehicle 1 location in memory 58, and associates the vehicle location information with the error code information, such that an individual (e.g., technician) and/or diagnostic tool accessing memory 58 to retrieve error code information will know that the vehicle 1 location information is associated with a given error code and occurrence.

Navigation module 40 also includes memory 49. In the present embodiment, memory 49 is flash memory. In alternate embodiments, memory 49 may include read only memory (ROM), EEPROM, and other non-volatile and volatile memory. Navigation module 40 is also configured to determine when an error condition occurs in navigation module 40. In the present embodiment, navigation module 40 is configured to determine when a GPS signal is either unavailable, or inadequate for processing, and to store an error code in memory 49 indicative of this error condition. Navigation module 40 is also configured to detect when there is an error in the map data associated with the determined vehicle 1 location, and to store an error code in memory 49 indicative of this error condition. Navigation module 40 is further configured to determine when there is an error in the determination of the vehicle location, and to store an error code indicative of this error condition in memory 49. Navigation module 40 is still further configured to store the determined vehicle 1 location at the time of the occurrence of any of the above or other error conditions in memory 49, provided that a determined vehicle location at the time of the error is available. The determined vehicle 1 location at the time of the occurrence of an error is stored in conjunction with the error code for that given error, such that when an individual or diagnostic tool accesses memory 49, the individual and/or tool is able to retrieve the error and associated location information, and determine the vehicle 1 location at the time of the occurrence of the associated error in question. In the present embodiment, this is accomplished by storing the determined vehicle 1 location and associated error code near each other in memory 49. In alternate embodiments, the vehicle 1 location and associated error code are associated with each other, and can be retrieved as related information even if not stored near each other in memory 49.

In an alternate embodiment of navigation module 40, if a determined vehicle location at the time of an error in navigation module 40 is unavailable, which may be the case when a GPS signal is corrupt or unavailable, navigation module 40 is configured to store the last good known vehicle location prior to the occurrence of the error condition, or to determine the vehicle location using means other than a GPS signal, such as, for example, by using dead reckoning calculations from a known position. In this alternate embodiment, the last good known location and/or vehicle location determined by means other than a GPS signal is stored as a determined vehicle location in the memory of navigation module 40, in conjunction with an error code, such that when an individual or diagnostic tool accesses memory 49, the individual and/or tool is able to retrieve the error and associated location information, and determine the vehicle 1 location at the time of the occurrence of the error in question. This is accomplished by storing the determined vehicle 1 location and associated error code near each other in memory 49. In alternate embodiments, the vehicle 1 location and associated error code are associated with each other, and can be retrieved as related information even if not stored near each other in memory 49.

Also shown in FIG. 2 are additional details for vehicle audio module 30. As shown, vehicle audio module 30 includes audio tuner/processing circuitry 32 configured to decode broadcast audio signals received via antenna 3. Vehicle audio module 30 also includes CD control/processing circuitry 34 configured to control a CD player, and amplification circuitry 36 configured to amplify decoded audio signals provided by audio tuner/processing circuitry 32, and/or CD control/processing circuitry 34, and provide those signals as audio signals to vehicle 1 occupants.

Vehicle audio module 30 is also shown including memory 38 configured to store information, such as error codes. In the present embodiment, memory 38 is flash memory. In alternate embodiments, memory 38 may include read only memory (ROM), EEPROM, and other non-volatile and volatile memory. Vehicle audio module 30 is configured to determine when a signal received by vehicle audio module 30 from antenna 3 is either lacking, or inadequate, and to store an error code indicative of this error condition in memory 38. Vehicle audio module 30 is further configured to determine when a skip, mute audio, and/or tracking error has occurred during playback of a CD, and to store an error code indicative of this error condition in memory 38. Vehicle audio module 30 is further configured to send a request via communication bus 9 to navigation module 40 when an error occurs in vehicle audio module 30. The request sent by vehicle audio module 30 requests navigation module 40 to provide information indicative of the location of vehicle 1 at the time the error in question occurred. Navigation module 40 provides information indicative of the vehicle 1 location at the time of the error to vehicle audio module 30 via communication bus 9. Vehicle audio module 30 stores the vehicle 1 location information in memory 38, along with the associated error code information, such that when an individual and/or diagnostic tool accesses memory 38 for error code information, the individual and/or diagnostic tool is able to determine the vehicle 1 location at the time of the occurrence of the error in question.

As noted above, vehicle 1 also includes a bus access port 22 coupled to communication bus 9. Bus access port 22 is configured, such that the diagnostic tool may be coupled to bus access port 22 to allow a diagnostic tool to retrieve error code and vehicle location information from satellite receive module 50, vehicle audio module 30, navigation module 40, or other modules coupled to communication bus 9.

In the present embodiment, memory 58 of satellite receive module 50, memory 38 of vehicle audio module 30, and memory 49 of navigation module 40 are non-volatile flash memory. In an alternate embodiment, error codes and/or vehicle location information are stored in electronic devices and/or modules in storage devices other than non-volatile flash memory. In yet another alternate embodiment, error codes and associated vehicle location information are retrieved directly from an electronics device, such as a module, without the need to access the electronics device via a communication bus.

In addition to the embodiments described above, it should be appreciated that in an alternate embodiments, the vehicle electronics modules of the present invention may be configured to automatically provide the determined vehicle location information and associated error code information to individuals or electronic devices external to the vehicle electronic modules without requiring that the individuals and/or external electronic devices first request the information. For example, in one alternate embodiment, the vehicle electronics modules of vehicle 1 are configured to provide determined vehicle location information and error code information via a wireless connection to a remote electronic device at a pre-determined time on a daily basis. It should be appreciated that the frequency of the provision of the information to the remote electronics device can be altered without departing from the spirit of the invention.

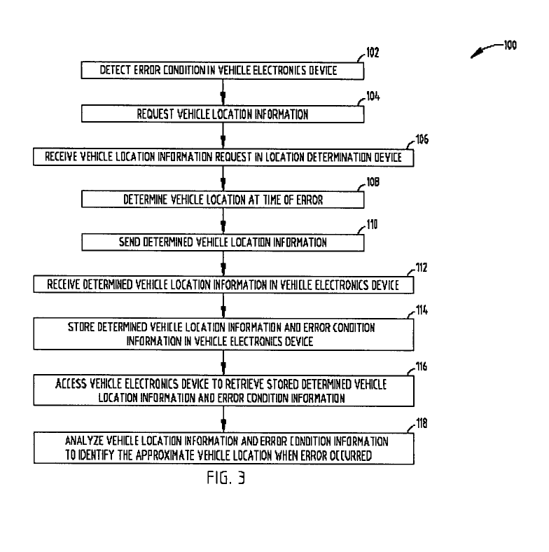

Referring to FIG. 3, a method 100 for storing the location of a vehicle during an error condition is provided. In a first step 102 of the method 100, an error condition is detected in a vehicle electronics device. In a second step 104 of the method 100, the vehicle electronics device requests vehicle location information. In a third step 106 of the method 100, the request for vehicle location information is received by a location determination device. In a fourth step 108 of the method 100, the vehicle location at the time of the error is determined by the location determination device. In a fifth step 110 of the method 100, the determined vehicle location information is sent by a location determination device. In a sixth step 112 of the method 100, the determined vehicle location information is received by the vehicle electronics device. In a seventh step 114 of the method 100, the error condition information and the associated determined vehicle location information are stored in the vehicle electronics device. In an eighth step 116 of the method 100, the vehicle electronics device is accessed to retrieve the stored determined vehicle location information and associated error condition information. In a ninth step 118 of the method 100, the vehicle location information and error condition information are analyzed to identify the approximate vehicle location when the error condition occurred.

It should be appreciated that in alternate embodiments, the location determination device may continuously track the location of the vehicle, and store past vehicle locations based on time, such that if a vehicle electronics device requests the vehicle location for an earlier time, the location determination device is capable of providing the vehicle location at that earlier time. While the location determination devices of the present embodiment include navigation modules and/or GPS circuitry, it should be appreciated that other location determination devices, such as Loran and/or compass-based devices, cell phones, dead reckoning devices or other devices capable of determining vehicle location, may be employed with or without GPS data to provide a vehicle location. It should also be appreciated that error conditions could include errors other than those specifically identified above.

Although the above-described embodiments are directed primarily to error situations in electronics modules, and the determination of a vehicle location when an error occurs, it should be appreciated that in alternate embodiments, a vehicle location can be determined when conditions of interest that are not necessarily error conditions, occur. In addition to error conditions, conditions of interest may include a vehicle reaching or exceeding a certain speed or RPM, a fuel level of a vehicle reaching a certain level, such as, for example, 1 gallon remaining in the tank, an oil life monitor of a vehicle reaching a certain level (such as, for example, 0 percent), or other conditions associated with the operation of a motor vehicle. These conditions of interest are determined by various electronics modules in a manner similar to that described above with respect to error conditions, and are stored and accessed as noted above with respect to error conditions and associated vehicle locations.

In one alternate embodiment, a condition of interest is an increased bit error rate (BER) in a satellite receiver in certain locations. An increased bit error rate could be of interest to system engineers in identifying a suboptimal system design or a diminished satellite signal strength in certain geographic areas through which users of the satellite receiver are traveling. By providing information about the condition of interest and associated location of the receiver during the condition of interest, this embodiment can enable system engineers to improve overall system performance.

In yet another alternate embodiment, a condition of interest is a high demand for traction control activation of a vehicle dynamics module on roads located in certain geographic areas. System engineers could use this condition of interest information, along with the associated location of the vehicle during the condition of interest, to verify that the vehicle dynamics module is functioning as expected, and to identify road areas that are particularly problematic.

In still another alternate embodiment, a condition of interest is shocks or impulses of certain magnitudes detected by modules configured to monitor and/or control a vehicle suspension. In this alternate embodiment, the condition of interest information and associated vehicle location during the condition of interest could be used to identify the location of adverse road conditions, such as chuckholes, damaged pavement, improperly installed manhole covers, and depressions in the pavement. In one specific alternate embodiment, municipal vehicles employ the present invention to track conditions of interest, and to provide the condition of interest information and associated vehicle location during the condition of interest to the municipality, where information from multiple vehicles is logged and tracked. In this manner specific problem areas can be identified, such as, for example, by identifying the frequency with which certain locations are captured by various municipal vehicles as being associated with conditions of interest.

In still another alternate embodiment, a condition of interest is a condition in which an engine control module is identifying engine performance that is satisfactory but suboptimal in certain conditions. For example, the engine control module might identify that performance is suboptimal when the vehicle is climbing hills of a certain grade, and might capture that condition of interest along with the associated location. System engineers accessing the condition of interest information and associated vehicle location during the condition of interest can use that information to determine the location of the condition of interest. By determining the road grade at the determined location, system engineers can then adjust engine design parameters to improve vehicle performance at the determined grade.

The embodiments of the present invention described above advantageously provide for systems and methods for storing the location of a vehicle during the occurrence of an error condition, such that individuals and/or tools diagnosing the error condition can determine the location of the vehicle at the time of the occurrence of the error. The systems and methods advantageously allow for the addition of vehicle location information to the error condition analysis process, enabling a more comprehensive root cause analysis and strategies to address the error conditions.

In addition to the embodiments described above, alternate embodiments are possible in which the location of electronic devices not proximate a vehicle can be stored when the electronics devices detect error conditions. In one specific alternate embodiment, a cellular telephone including location determination circuitry is configured to detect error conditions in the cellular telephone. The cellular telephone is additionally configured to store error information associated with the detected error conditions, along with the location of the cellular telephone at the time the error is detected, in memory of the cellular telephone. The location is provided by the location determination circuitry of the cellular telephone. In one specific alternate embodiment, the location determination circuitry is GPS circuitry, and the error condition is the loss of a cellular signal or a cellular signal falling below a predetermined power level. The cellular telephone may additionally be configured to periodically provided error code information and associated location information to individuals and/or electronic devices external to the cellular telephone. In one embodiment, the cellular telephone automatically provides the error code information and associated location information to additional electronic devices via a cellular link.

It should be appreciated that although the embodiments described above describe an error condition being detected by various modules and/or electronic devices, conditions other than error conditions, such as conditions of interest, may be detected and stored along with the location of the vehicle and/or electronics device at the time of the condition of interest.

The above description is considered that of the preferred embodiments only. Modifications of the invention will occur to those skilled in the art, and to those who make or use the invention. Therefore, it is understood that the embodiments shown in the drawings and described above are merely for illustrative purposes, and not intended to limit the scope of the invention, which is defined by the following claims, as interpreted according to the principles of patent law, including the doctrine of equivalents.

1. A system for storing the location of a vehicle during an error condition, comprising:
a vehicle electronics device located at least one of in and on a vehicle and comprising memory, said vehicle electronics device being configured to perform a first function, said vehicle electronics device being further configured to detect an error condition associated with said vehicle electronics device; and
a location determination device proximate said vehicle and coupled to said vehicle electronics device, wherein said location determination device is configured to determine a vehicle location and provide information indicative of the vehicle location, and wherein said vehicle electronics device is configured to store vehicle location information provided by said location determination device in said memory when an error condition is detected, and wherein the stored vehicle location information is indicative of the vehicle location at a time said vehicle electronics device detects an error condition.

2. The system of claim 1, further comprising a communication bus at least one of electrically and electromagnetically coupled to said vehicle electronics device and said location determination device, wherein said vehicle electronics device is configured to receive vehicle location information from said location determination device via said communication bus.

3. The system of claim 2, wherein said communication bus is at least one of a GM-LAN, CAN, J-1850, USB, Firewire, 12C, 802.11, Bluetooth® and MOST communication bus.

4. The system of claim 2, further comprising a bus access port coupled to said communication bus, wherein said bus access port is configured to permit a diagnostic device to retrieve the vehicle location information from said vehicle electronics device.

5. The system of claim 1, wherein said vehicle electronics device includes an access port, wherein said access port is configured to couple to a diagnostic device to permit the diagnostic device to retrieve the vehicle location information from said vehicle electronics device.

6. The system of claim 1, wherein said vehicle electronics device is further configured to store error information indicative of a detected error condition in conjunction with related vehicle location information in said memory, such that error information and related vehicle location information can be retrieved together.

7. The system of claim 1, wherein said location determination device comprises a navigation module comprising circuitry configured to receive GPS signals.

8. The system of claim 7, wherein said navigation module further comprises memory, and wherein said navigation module is configured to detect an error condition associated with said navigation module, and is further configured to store vehicle location information in said memory of said navigation module, wherein the stored vehicle location information stored in said memory of said navigation module is indicative of the approximate vehicle location at a time said navigation module detects an error condition.

9. The system of claim 8, wherein an error condition detected by said navigation module is at least one of a corrupt global positioning satellite signal, loss of a global positioning satellite signal, and error in a map associated with said navigation module.

10. The system of claim 1, wherein said vehicle electronics device comprises audio circuitry, and wherein an error condition detected by said vehicle electronics module is at least one of a loss of a satellite signal, loss of a digital radio signal, loss of an analog radio signal, and tracking error of a digital disk player.

11. The system of claim 1, wherein said vehicle electronics device is a navigation module, and wherein said location determination device comprises GPS circuitry.

12. The system of claim 1, wherein said vehicle electronics device is at least one of electrically and electromagnetically coupled to an electronics device external to said vehicle electronics device, and wherein said vehicle electronics device is configured to provide the stored vehicle location information and associated error information to the electronics device external to said vehicle electronics device.

13. The system of claim 12, wherein said vehicle electronics device is configured to provide the stored vehicle location information and associated error information periodically at a predetermined frequency.

14. A method for storing the location of a vehicle during an error condition, comprising the steps of:
detecting an error condition in a vehicle electronics module located at least one of in and on a vehicle;
determining the vehicle location near the time of the detected error condition in a location determination device proximate the vehicle and coupled to the vehicle electronics module;
providing the determined vehicle location to the vehicle electronics module; and
storing the determined vehicle location in the vehicle electronics module.

15. The method of claim 14, further including the step of storing detected error condition information associated with the determined vehicle location in the vehicle electronics module.

16. The method of claim 15, further including the step of coupling a diagnostic device to the vehicle electronics module and retrieving the determined vehicle location and associated detected error condition information from the vehicle electronics module.

17. The method of claim 15, wherein the location determination device is coupled to the vehicle electronics module by means of a communication bus, and further including the steps of coupling a diagnostic device to the communication bus and retrieving the determined vehicle location and associated detected error condition information from the vehicle electronics module via the communication bus.

18. The method of claim 14, further including the steps of sending a location request to the location determination device from the vehicle electronics module when the vehicle electronics module detects an error condition, and providing the determined vehicle location to the vehicle electronics module responsive to the location request.

19. The method of claim 14, wherein the vehicle electronics module comprises an audio module, and wherein the detected error condition is at least one of loss of a satellite signal, loss of a digital radio signal, loss of an analog radio signal, and tracking error of a digital disk player.

20. The method of claim 14, wherein the location determination device comprises a navigation module including memory and configured to detect an error condition in the navigation module, further comprising the steps of detecting an error condition in the navigation module, determining the vehicle location at the time of the detected error condition in the navigation module, and storing detected error condition information and the determined vehicle location in the memory.

21. The method of claim 14, further including the step of providing the determined vehicle location and associated error information to an electronics device external to the vehicle electronics module.

22. The method of claim 21, wherein the determined vehicle location and associated error information are provided periodically at a predetermined frequency.

23. A method for storing the location of a vehicle during an error condition, comprising the steps of:
detecting an error condition in a vehicle electronics module located at least one of in and on a vehicle and coupled to a communication bus;
sending a location request via the communication bus requesting a location of the vehicle near the time of the detected error condition;
receiving the location request in a navigation module located in the vehicle and coupled to the communication bus;
determining the location of the vehicle near the time of the detected error condition in the navigation module;
sending information indicative of the location of the vehicle near the time of the detected error condition via the communication bus;
receiving the information indicative of the location of the vehicle near the time of the detected error condition in the vehicle electronics module; and
storing the information indicative of the location of the vehicle near the time of the detected error condition in memory of the vehicle electronics module.

24. A method for storing the location of an electronics device during a condition of interest, comprising the steps of:
detecting a condition of interest in an electronics device that is at least one of portable and located at least one of in and on a vehicle in a location determination device coupled to the electronics device;
determining the location of the electronics device near the time of the detected condition of interest; and
storing the condition of interest information and information indicative of the location of the electronics device near the time of the detected condition of interest in memory of the electronics device.

25. The method of claim 24, wherein the electronics device is a navigation module located at least one of in and on a vehicle and including location determination circuitry, and wherein the location of the vehicle is determined by the location determination circuitry.

26. The method of claim 24, further including the step of providing the condition of interest information, and information indicative of the location of the electronics device near the time of the detected condition of interest, external to the electronics device.

27. A system for storing the location of an electronics device during a condition of interest, comprising:
an electronics device comprising memory and configured to perform a first function, said electronics device being further configured to detect a condition of interest associated with said electronics device; and
a location determination device proximate said electronics device and coupled to said electronics device, wherein said location determination device is configured to determine the location of said electronics device and provide information indicative of the location of said electronics device, and wherein said electronics device is configured to store electronics device location information provided by said location determination device in said memory when a condition of interest is detected, and wherein the stored electronics device location information is indicative of the location of the electronics device at a time said electronics device detects a condition of interest.
